(19) United States
(12) Patent Application Publication
(10) Pub. No.: US 2008/0191964 A1
(43) Pub. Date: Aug. 14, 2008

(54) Auto-Stereoscopic Display With Mixed Mode For Concurrent Display of Two- and Three-Dimensional Images

(75) Inventor: Jeffrey M. Spengler, Monroe, WA (US)

Correspondence Address: PHILIPS INTELLECTUAL PROPERTY & STANDARDS, P.O. BOX 3001, BRIARCLIFF MANOR, NY, 10510, US

(73) Assignee: KONINKLIJKE PHILIPS ELECTRONICS, N.V., EINDHOVEN (NL)

(21) Appl. No.: 11/911,997

(22) PCT Filed: Apr. 17, 2006
(86) PCT No.: PCT/IB2006/051185

§ 371 Date: Oct. 19, 2007

Related U.S. Application Data
(60) Provisional application No. 60/674,255, filed on Apr. 22, 2005.

(51) Int. Cl. G09G 5/00

(52) U.S. Cl. 345/6

(57) ABSTRACT

An auto-stereoscopic display (104) is operable in mixed mode so as to divide the screen spatially into two- and three-dimensional areas, respectively (S332,S336). Accordingly, metadata (260) of a three-dimensional image can be displayed two-dimensionally alongside the image, and can be seen clearly from various viewpoints.

The present invention relates to stereoscopic displays, and particularly to operation modes of stereoscopic displays.

There are many medical imaging modalities that currently collect three-dimensional (3-D) data and display it to the clinician for diagnosis.

However, diagnostic images are currently displayed using a 2-D monitor. The 2-D capability is suitable for certain graphs, measurements or other metadata displayed concurrently on-screen with the image. However, as for the image, the user must interpret the 2-D display in 3 dimensions. This can sometimes be difficult, and error-prone. It is difficult to understand the special orientation of the 3-D image presented on a 2-D monitor, which could lead to misdiagnosis.

A stereoscopic monitor recently developed can display 3D data in 3D, but visual artifacts may develop if the user's head strays from a particular distance and orientation with respect to the display. However, this problem is overcome by assuming a comfortable position and retaining it during viewing.

If during a break, the clinician glances at the screen, visibility of the on-screen information may be impaired, and this includes the metadata. Yet, the metadata might be of a type that does not lend itself to 3-D rendition, i.e., the patient's name, the type of imaging, etc. The Digital Imaging and Communications in Medicine (DICOM) standard combines, in the same file, images and header information that includes the patient's name, the type of scan, etc. Thus, although the reviewer of diagnostic images may just want to see who the patient is, the reviewer is put to the inconvenience of rediscovering, by trial and error, the approximate sitting and head position that will regain the “sweet spot.”

There, accordingly, exists a need to benefit from the advantages of displaying 3-D medical diagnostic images on a 3-D display, but without the disadvantages that surround concurrently presenting, on-screen, metadata suitable for viewing in 2-D. Such a 3-D display would preferably be auto-stereoscopic, like the prior art display noted above, to avoid the need for goggles. They are cumbersome to wear, leave the user connected to the medical device by a video cable, and restrict the peripheral view of the user. Moreover, viewing 2-D data is less optimal with goggle-based methods.

The shortcomings of the prior art noted above are addressed by the present, inventive display that is operable to spatially divide an image into 2-D and 3-D areas.

In brief, an apparatus that includes a stereoscopic display, also includes a processor that selects from among at least two modes of operation of the display. In particular, selection is made from among a three-dimensional mode, and a mixed mode that spatially divides an image displayed into areas that simultaneously display in two and three dimensions respectively.

Details of the invention disclosed herein shall be described with the aid of the figures listed below, wherein:

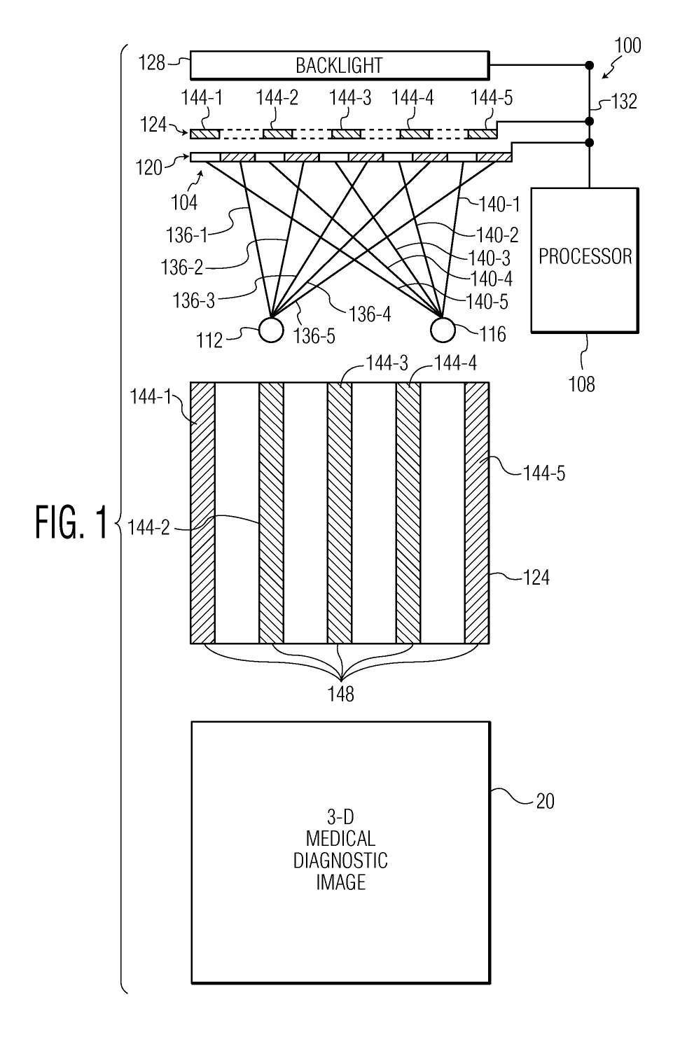

FIG. 1 is a conceptual diagram depicting an apparatus, including display panels in 3-D mode, according to the present invention;

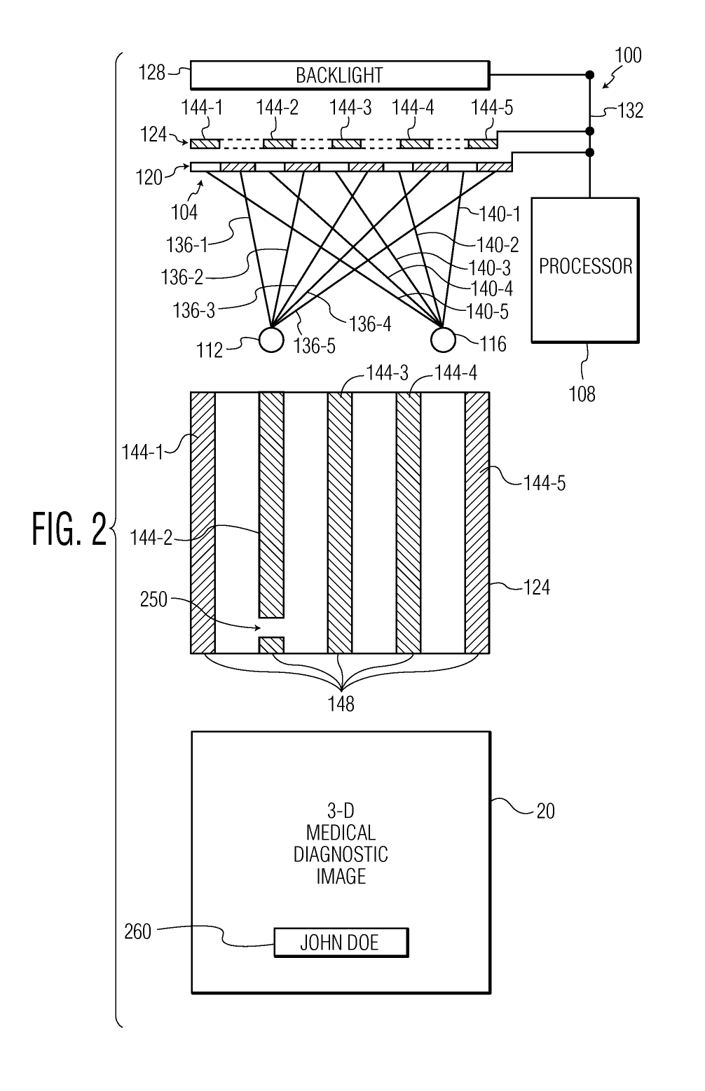

FIG. 2 is a conceptual diagram depicting an apparatus, including display panels in mixed mode, according to the present invention; and

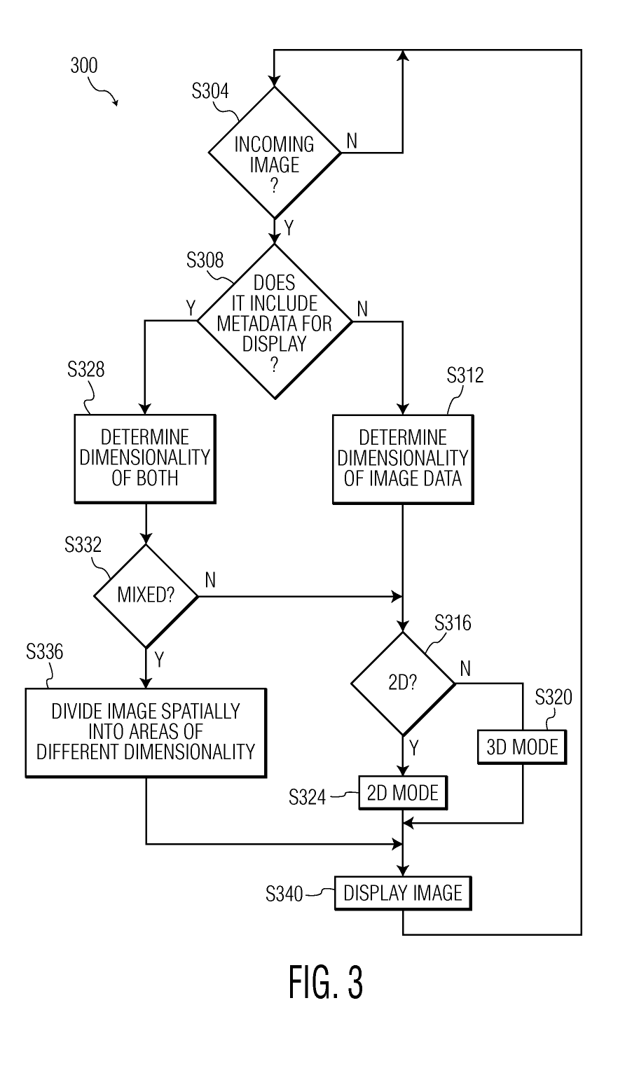

FIG. 3 is a flowchart of a process applied to an incoming image according to the present invention.

Referring now in specific detail to the drawings in which like reference numerals identify similar or identical elements throughout the several views, and initially to FIG. 1, an overview is shown of an exemplary architecture for a display apparatus 100 according to the present invention. FIG. 1 particularly relates to the 3-D mode of the display apparatus 100, and is provided by way of illustrative and non-limitative example.

The display apparatus 100 includes a stereoscopic display 104 and a processor 108. The stereoscopic display 104 is auto-stereoscopic, although the intended scope of the present invention is not limited to this. An auto-stereoscopic display provides a stereoscopic image viewable without goggles or any intervening optics between the display and the viewer's eyes 112, 116.

The display 104 has a light-modulation panel 120, a parallax panel 124 and a backlight 128. The panels 120, 124 and the backlight are connected to the processor 108 by a data and control bus 132. Both panels 120, 124 may be implemented as liquid crystal displays (LCDs).

FIG. 1 shows, for simplicity of demonstration, the light-modulation panel 120 as having merely ten pixels, each being identified by a line-of-sight (LOS) from the respective eye 112, 116. To avoid cluttering the diagram, reference will be made hereinafter to the reference number of the respective LOS in identifying a pixel. Accordingly, the left eye 112 has a LOS to pixels 136-1, 136-2, 136-3, 136-4, 136-5; likewise, the right eye 116 has a LOS to pixels 140-1, 140-2, 140-3, 140-4, 140-5. Since the panels 120, 124 both extend out perpendicularly to the surface of FIG. 1, these ten pixels represent merely one of many rows of pixels embodied within the light-modulation panel 120. Also, any row of the light-modulation panel 120 will generally have many more than the ten pixels shown. A front-wise view of the light-modulation panel 120, presenting, for example, a 3-D medical diagnostic image, appears at the bottom of FIG. 1.

The splitting of the pixels 136-1, . . . 136-5, 140-1, . . . 140-5 into two groups separately viewable, i.e., one group by the left eye 112 and the other group by the right eye 116, is accomplished by means of the effect of the parallax panel 124 on the lighting provided by the backlight 128. The backlight 128 typically might be a fluorescent bulb, and may include several bulbs arranged in parallel across the parallax panel 124. In short, the left eye 112 is excluded from seeing the pixel 140-4, for example, because the parallax panel 124 blocks light from the backlight that might otherwise illuminate that pixel in a LOS intermediate between the lines-of-sight 136-1, 136-2. In effect, that intermediate LOS does not exist for the left eye 112, and is accordingly not depicted in FIG. 1. This method of bifurcation between eyes 112, 116 will be explained further in the discussion that follows.

The parallax panel 124, implemented as an LCD, provides vertical strips or columns 144-1, . . . , 144-5, each of whose pixels (not shown) are operable to vary in transparency. The vertical strips 144-1, . . . , 144-5, which typically number many more than 5, comprise a parallax barrier 148. The areas between each vertical strip 144-1, . . . , 144-5 can be left permanently transparent, or implemented separately with an invariably transparent material, e.g., clear glass or plastic. Alternatively, the vertical strips 144-1, . . . , 144-5 can be constantly shifting laterally in phase, with a corresponding, continuing re-assignment of light-modulation pixels so as to preserve parallax effects to be discussed below.

LOS 136-1 exists for the left eye 112, because light from the backlight 128 penetrates the transparent area between the vertical strips 144-1, 144-2 to illuminate the pixel 136-1 in alignment with that LOS. By contrast, and as mentioned above, the left eye 112 is unable to see the pixel 140-4, because the vertical strip 144-2 of the parallax barrier 148 blocks light that might otherwise illuminate the pixel in alignment with a LOS to the left eye. Analogous principles apply for each of the pixels 136-1, . . . 136-5, 140-1, . . . 140-5.

Stereoscopic vision requires that each eye see a similar image, but varying according to the differing viewpoints. The mind blends the two images to provide the visual appearance of depth characteristic of a 3-D view. Accordingly, the processor 108 operates the two groups of pixels to provide the slightly different perspectives to respective eyes 112, 116.

FIG. 2 shows the same apparatus 100 operating in mixed mode, rather than in 3-D mode. In mixed mode, the image to be displayed is spatially divided into areas, at least one of which is displayed in 2-D mode and at least one other of which is displayed in 3-D mode. A 2-D mode is also possible, in which the image displayed on-screen totally in 2-D.

Notably, in FIG. 2, a part 250 of the vertical strip 144-2 has been switched into transparency. In particular, each pixel of which the part 250 is comprised has been made transparent. This allows a 2-D area 260 to display where the part 250 is located. The corresponding pixels of the light-modulation panel 120 are driven by 2-D data, rather than 3-D data. The latter, as discussed above in connection with the pixels of the light-modulation panel, is arranged to alternate by eye 112, 116 pixel-to-pixel. The 2-D data, by contrast, is organized in consecutive pixels that represent a single image.

The 2-D area 260 may be dynamically reconfigurable as to size and location. However, the 2-D area 260 is brighter, owing to the transparency of the part 250. Accordingly, if the incoming metadata is uniform in format, the 2-D area may be fixed, and a polarizer or other film may be utilized, e.g., on the inside of the screen, to attenuate light intensity and thereby compensate for the extra brightness.

FIG. 3 represents one example of a display process 300 applied to an image received by the display apparatus 100 (step S304). The image is here assumed to be a still image, although the image may be a video or graphic image. The image may arrive in real-time from the acquisitions of an imaging device applied to medical subject, or may be retrieved from previous storage. If the image is part of a DICOM file, it includes image data and is accompanied by a header that contains metadata, e.g., image modality, slice thickness, etc., of the image data. If the image does not include metadata that is to be displayed (step S308), the processor 108 determines the dimensionality, i.e., 2-D or 3-D, of the image data (step S312). The dimensionality of image data (or metadata), in general, is a characteristic that can be determined by applying a predetermined criterion. The dimensionality is derived, for example, from information in the file or can be determined upon inspection of the pixel format of the image data (or metadata) (step S316). On the other hand, if the incoming image includes metadata for display, dimensionality is determined for both the image data and the metadata to be displayed (step S328). If the image data and metadata do not differ as to dimensionality (step S332), it is determined whether the image is 2-D or 3-D (step S316). If the image is 2-D (step S324), the parallax panel 124 is made completely transparent. If the image is 3-D, the parallax barrier 148 is opaque (step S320). If, however, the image data has a dimensionality that differs from that of the metadata, the image is divided spatially for display into areas of different dimensionality (step S336). Thus, one or more areas of the display are assigned to respective one or more portions of the metadata to be displayed. The part or parts 250 of corresponding vertical strips 144-1, . . . , 144-5 are made transparent to allow the assigned 2-D areas of the light-modulation panel 120 to be illuminated by the backlight 128 unimpeded, and in a conventional 2-D manner. With the parallax barrier 148 pre-set according to the above considerations, the image is then presented on the auto-stereoscopic display (step S340). If the operation mode switches from mixed to 3-D, due, for example, to eliminating display of metadata, transparency in the part or parts 250 is reduced.

Optionally, once dimensionality is determined for incoming image data or metadata, that dimensionality may be converted, i.e., 2-D to 3-D, or 3-D to 2-D. Thus, 3-D metadata may be made 2-D for easy readability from various viewpoints.

The display process 300 may be implemented in any combination hardware, software or firmware.

In referring above to 2-D and 3-D data, dimensionality from the stereoscopic display standpoint is implied. No limitation is otherwise placed on the dimensionality of data that may be displayed.

As has been demonstrated above, images, and especially medical, diagnostic images, can be displayed with greater accuracy in 3-D while retaining the flexibility of various viewpoints for metadata presented in 2-D.

While there have shown and described and pointed out fundamental novel features of the invention as applied to preferred embodiments thereof, it will be understood that various omissions and substitutions and changes in the form and details of the devices illustrated, and in their operation, may be made by those skilled in the art without departing from the spirit of the invention. For example, it is expressly intended that all combinations of those elements and/or method steps which perform substantially the same function in substantially the same way to achieve the same results are within the scope of the invention. Moreover, it should be recognized that structures and/or elements and/or method steps shown and/or described in connection with any disclosed form or embodiment of the invention may be incorporated in any other disclosed or described or suggested form or embodiment as a general matter of design choice. It is the intention, therefore, to be limited only as indicated by the scope of the claims appended hereto.

1. An apparatus (100) comprising:
a stereoscopic display (104); and
a processor (108) configured for selecting from among at least two modes of operation of the display, in particular a three-dimensional mode (S320), and a mixed mode (S332) that spatially divides an image displayed into areas that simultaneously display in two and three dimensions respectively on said stereoscopic display (120).

2. The apparatus of claim 1, wherein said display is configured to display auto-stereoscopically (104).

3. The apparatus of claim 1, wherein said display has a parallax barrier (148) that includes vertical strips (144-2), said display being configured to make part (250) of at least one of the strips transparent during said mixed mode.

4. The apparatus of claim 3, wherein said display is configured to reduce transparency in said part if and when the operation mode is switched from mixed to three-dimensional (260).

5. The apparatus of claim 3, wherein said monitor includes a backlight (128), a light-modulation panel (120), and an intervening, parallax panel (124) that embodies said parallax barrier.

6. The apparatus of claim 3, wherein the display is configured to make transparent respective parts (250) of a plurality of said strips (144-1, . . . , 144-5), to thereby form, in mixed mode, an area of said areas that displays two-dimensionally (260).

7. The apparatus of claim 1, wherein said processor is configured to make the selection based on a characteristic of incoming data for display (S312, S328).

8. The apparatus of claim 7, wherein said image includes image data and metadata of the image data, said processor being configured for determining whether the image data is three-dimensional and whether the metadata is three-dimensional (S328), said processor being further configured for selecting said three-dimensional mode (S320) if both the image data and the metadata are determined to be three-dimensional, and for selecting said mixed mode (S332) if one of the image data and the metadata is three-dimensional and the other of the image data and the metadata is not three-dimensional.

9. The apparatus of claim 8, wherein said processor is configured to select a two-dimensional mode (S324) if both the image data and the metadata are two-dimensional.

10. The apparatus of claim 7, wherein said processor is configured for displaying, on-screen, image data and metadata of the image data, and further configured to apply a predetermined criterion to said metadata to detect said characteristic and to perform said selecting based on an outcome of the applying (S316, S328, S332).

11. The apparatus of claim 7, wherein said processor is configured for displaying, on-screen, image data and metadata of the image data, and further configured to apply a predetermined criterion to said metadata to detect said characteristic and to perform the dividing among areas based on an outcome of the applying (S336).

12. The apparatus of claim 1, wherein said processor is further configured to assign two-dimensionality or three-dimensionality to respective ones of said areas based on an outcome of applying a predetermined criterion to metadata that arrives together with incoming image data for display (S320, S324, S332).

13. A method for stereoscopic display, comprising:
providing an image for display on a stereoscopic monitor (S304);
selecting from among at least two modes of operation of the display, in particular a three-dimensional mode (S320), and a mixed mode (S332); and
if said mixed mode is selected, spatially dividing said image into areas that simultaneously display in two and three dimensions respectively on said monitor (S336, S340).

14. The method of claim 13, comprising:
determining, by a processor, a characteristic of data to be displayed on said monitor (S328);
selecting, by the processor, mixed mode based on an outcome of the determination (S332); and
performing said dividing (S336).

15. The method of claim 13, comprising:
receiving data to be displayed on said monitor, said data comprising image data and metadata for the image data (S304, S308);
applying a predetermined criterion to said metadata to arrive at an outcome (S312, S328); and
making the selection based on the outcome (S316, S332).

16. The method of claim 13, wherein said data comprises three-dimensional diagnostic medical image data for display on said monitor (120).

17. The method of claim 13, wherein said monitor comprises an auto-stereoscopic display monitor (104).

18. The method of claim 13, wherein said providing provides a parallax barrier (148) having vertical strips (144-2), said selecting of mixed mode causing part (250) of at least one of the strips to become transparent.

19. The method of claim 18, comprising making transparent respective parts of a plurality of said strips (144-1, . . . , 144-5), to thereby form, in mixed mode, an area of said areas that displays two-dimensionally (260).

20. The method of claim 18, comprising reducing transparency in said part if and when the operation mode is switched from mixed to three-dimensional (260).

21. A computer software product for stereoscopic display (104), said product being embedded within a medium readable by a processor (108), said product comprising instructions executable to perform acts comprising:
providing an image for display on a stereoscopic monitor (S304);
selecting from among at least two modes of operation of the display, in particular a three-dimensional mode (S320), and a mixed mode (S332); and
if said mixed mode is selected, spatially dividing said image into areas that simultaneously display in two and three dimensions respectively on said monitor (S336).
